(19) United States
(12) Patent Application Publication
(10) Pub. No.: US 2022/0405794 A1
(43) Pub. Date: Dec. 22, 2022

(54) System and method for throttling communications with consumer devices

(71) Applicant: GROUPON, INC., Chicago, IL (US)

(72) Inventors: Amit Aggarwal, Sunnyvale, CA (US); Kevin Chang, Mountain View, CA (US); David Thacker, Burlington, CA (US); Pu Wang, Berkeley, CA (US)

(21) Appl. No.: 17/716,785

(22) Filed: Apr. 8, 2022

Related U.S. Application Data
(63) Continuation of application No. 13/839,142, filed on Mar. 15, 2013, now abandoned.
(60) Provisional application No. 61/635,162, filed on Apr. 18, 2012.

(51) Int. Cl. G06Q 30/02

(52) U.S. Cl. CPC G06Q 30/0223

(57) ABSTRACT

A system and method for throttling communications with consumer devices is disclosed. The consumer devices are associated with consumers and consumers are associated with preferred types of electronic correspondence. The system and method transmits to a first set of the consumer devices a first electronic correspondence including a deal from a deal program comprising an offer and an expiration date. The system and method receive responses to the first electronic correspondence and based on the responses and expiration of outstanding offers at the expiration date generates an indicator used to determine to communicate with one or more additional consumers through their consumer devices. The system and method generate additional electronic correspondence of the preferred type and transmit the additional electronic correspondence to the additional consumers. In this way, additional electronic correspondence may be throttled upward or downward.

### REFERENCE TO RELATED APPLICATION

This application is a continuation of and claims priority to U.S. patent application Ser. No. 13/839,142, filed Mar. 15, 2013, which claims the benefit of U.S. Provisional Application No. 61/635,162, filed Apr. 18, 2012, the entirety of each of which are hereby incorporated herein by reference in their entireties.

### TECHNICAL FIELD

The present description relates to offering deals associated with a product or a service. This description more specifically relates to a throttling system that works in combination with or as part of a relevance system for determining which deal to offer for a product or a service.

### BACKGROUND

Merchants typically offer deals to consumers. The deals offered may be part of a deal program and be in the form of promotions, discounts, rewards, or the like. When offering the deals from a deal program, a merchant may seek to focus the offer to a subset of its consumers. However, the number of deals that may be offered in a deal program may be limited. So that, determining which subset of consumers to offer a deal (particularly when the number of deals is limited) may prove difficult.

### SUMMARY

A method and system for throttling of consumer deals is provided.

In one aspect, a method for determining whether to offer a deal from a deal program to a consumer is provided. The method includes: accessing, in at least one memory, an estimated acceptance of outstanding offers from the deal program; accessing, in the at least one memory, a number of deals available from the deal program; determining an adjusted number of deals available based on the number of deals available and the estimated acceptance of the outstanding offers from the deal program; and determining whether to offer the deal to the consumer based on the adjusted number of deals available. The adjusted number of deals available may account for the likelihood that previous offers for deals are accepted. For example, the estimated acceptance of the outstanding offers used to determine the adjusted number of deals may be generated using information specific to the consumers that received the outstanding offers (such as specific estimate of acceptance by the consumers that received the outstanding offers) or may be generated using information independent of the consumers that received the outstanding offers (such as an average acceptance rate of deals offered from the deal program). Optionally, in addition to the adjusted number of deals, the estimate of acceptance by the consumer may be used in determining whether to offer the deal to the consumer. According to the method, the deals presented may either be throttled upward or downward depending on the adjusted number of deals.

In another aspect, a method for determining whether to offer a deal from a deal program to a consumer, with the deal for goods or services and with the deal program including an end period for offering deals from the deal program. The method includes: accessing, in at least one memory, consumer data indicative of at least one attribute associated with the consumer; analyzing the consumer data and deal data for the deal program in order to generate an estimate indicative of the consumer purchasing the deal; accessing, in the at least one memory, a number of deals available from the deal program; and determining whether to offer the deal to the consumer based on the estimate that the consumer will purchase the deal, based on the number of deals available, and based on the end period for offering the deals from the deal program.

In yet another aspect, an apparatus configured to determine whether to present a deal from a deal program to a consumer, with the deal for goods or services, is provided. The apparatus includes: at least one memory configured to store an estimated acceptance of outstanding offers from the deal program and a number of deals available from the deal program and a processor in communication with the at least one memory. The processor is configured to: access the estimated acceptance of the outstanding offers from the deal program; access the number of deals available from the deal program; determine an adjusted number of deals available based on the number of deals available and the estimated acceptance of the outstanding offers from the deal program; and determine whether to offer the deal to the consumer based on the adjusted number of deals available.

In still another aspect, an apparatus configured to determine whether to present a deal from a deal program to a consumer, with the deal for goods or services, and with the deal program including an end period for offering deals from the deal program. The apparatus including: at least one memory configured to store consumer data indicative of at least one attribute associated with the consumer and a number of deals available from the deal program and a processor in communication with the at least one memory. The processor is configured to: access the consumer data indicative of at least one attribute associated with the consumer; analyze the consumer data and deal data for the deal program in order to generate an estimate indicative of the consumer purchasing the deal; access the number of deals available from the deal program; and determine whether to offer the deal to the consumer based on the estimate that the consumer will purchase the deal, based on the number of deals available, and based on the end period for offering the deals from the deal program.

Other systems, methods, and features will be, or will become, apparent to one with skill in the art upon examination of the following figures and detailed description. It is intended that all such additional systems, methods, features and be included within this description, be within the scope of the disclosure, and be protected by the following claims.

### BRIEF DESCRIPTION OF THE DRAWINGS

The relevance system may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 shows a representation of a network and a plurality of devices that interact with the network, including a relevance system.

FIG. 2 shows a block diagram of the relevance system.

FIG. 3 is one example of a logic flow of throttling for a deal program.

FIG. 4 is a logic flow of throttling for a deal program category or a deal compilation.

FIG. 5A is one example of an expanded logic flow for FIG. 3.

FIG. 5B is another example of an expanded logic flow for FIG. 3.

FIG. 6 is one example of a logic flow for determining a sequence of users for examining whether to throttle an offer of a deal.

FIG. 7 is another example of a logic flow for determining a sequence of users for examining whether to throttle an offer of a deal.

FIG. 8 is still another example of an expanded logic flow for FIG. 3.

FIG. 9 is a general computer system, programmable to be a specific computer system, which may represent any of the computing devices referenced herein, such as the relevance system.

### DETAILED DESCRIPTION

The principles described herein may be embodied in many different forms. Not all of the depicted components may be required, however, and some implementations may include additional, different, or fewer components. Variations in the arrangement and type of the components may be made without departing from the spirit or scope of the claims as set forth herein. Additional, different or fewer components may be provided.

As discussed in the background, a consumer may be offered a deal. The deal may include, but is not limited to, any type of promotion, reward, discount, coupon, credit, voucher or the like used toward part (or all) of the use, purchase or ownership of a product or a service. The deal may be part of a deal program, which includes one or more attributes that describe the deals that may be offered as part of the deal program. One example of an attribute for the deal program includes the location of the deal from the deal program (e.g., the place of purchase of the product or service). Another example attribute is the category of the deal program (such as, for example, a “restaurant” category for a deal program that includes deals for a restaurant).

Still another example attribute is the number of deals from the deal program that are available for purchase (or acceptance). The number of deals available for purchase (or acceptance) may be limited to a specific number. In the case of a deal program for a product, for example, the number of products may be limited to “X” units. Likewise, in the case of a deal program for a service, the number of purchases of the service may be limited to “Y” units.

Yet another example of an attribute for a deal program may be the time period for offering deals from the deal program. A deal program may have a limited time during which a consumer may purchase or accept deals. In particular, the deal program may be limited to a few days, a week, a month, six months, and so on.

As discussed in more detail below, an offer to purchase or accept a deal from a deal program is transmitted to the consumer. The offer may be sent via an electronic correspondence in a variety of ways, such as an email, SMS text message, webpage inbox message, VOIP voice message, real-time webpage content presentation, mobile push notifications or other similar types of electronic correspondences where information is “pushed” onto a consumer. In one example, the consumer may have previously agreed to receive an e-mail transmitted daily. The e-mail includes the offer, or impression to the consumer, of a deal from the deal program. Further, throttling, as discussed below, may employ any one or multiple combinations of the listed forms of electronic correspondence in presenting offers to consumers.

In the instance that the deal program includes a limited number of deals (and the potential to sell out), it is advisable to monitor the impressions or the offers that are transmitted to the consumer. Otherwise, if too many offers have been transmitted to the consumer, and the deal program has sold out, offers for the deal program have been wasted. As discussed in more detail below, the offers for a particular deal may be throttled (either upward or downward) depending on the number of deals remaining.

One example of throttling is where the number of offers or impressions for the particular deal is throttled downward. In the case of throttling downward, the number of offers or impressions that is transmitted is reduced. In this example, the deals in the deal program are limited in number and may potentially sell out. In this regard, the throttling functionality is configured to examine an indicator of an adjusted number of deals still available in the deal program and/or one or more aspects of the potential consumers (such as the probability of the consumers to accept the deal if offered) in determining whether to send an offer of the deal. In one embodiment, the indicator is generated by adjusting the number of deals available from the deal program by one or both of the following: the outstanding offers (e.g., the estimated acceptance of the outstanding offers); and/or the estimated acceptance by the consumer. For example, the number of deals that are still available for purchase may be adjusted downward depending on the estimated acceptances of the outstanding offers in order to generate the adjusted number. Optionally, the determination whether to send the deal to a consumer may comprise comparing the estimated acceptance by the consumer with the adjusted number of deals still available. As another example, the determination whether to send the deal to a consumer may comprise comparing the estimated acceptance by the consumer with either the number of deals available from the deal program or the adjusted number of deals available (e.g., adjusted based on the outstanding offers).

By basing the determination whether to send the offer on the adjusted number of deals available and/or on one or more aspects of the potential customers, it is less likely that an excessive number of offers are sent to the potential consumers. As one example, offers may be sent in a batch transmission (such as in batch e-mails) to a set of potential consumers. The potential consumers may number in the hundreds, to thousands, to tens-of-thousands, or more. So that, many potential customers may be selected to receive an offer for a particular deal; however, with a limited number of deals available, the number of potential customers selected to receive the offer may be much higher than is recommended, e.g., as compared to a lesser number of customers receiving the offer that may nonetheless result in a comparable number of purchases and/or offer acceptances.

Instead of merely relying on the number of deals still available, an indicator of the adjusted number of deals remaining may be generated. As discussed above, in one embodiment, the indicator may be based on the number of deals that remain for purchase and offers that are outstanding. The indicator may then be used, along with one or more attributes of the specific consumer, in order to determine whether to offer the deal to the specific consumer, as discussed in more detail below. In an alternate embodiment, the determination whether to send an offer to the specific consumer may be based on the number of deals still available and the specific consumer's estimate of acceptance of the deal.

An outstanding offer is an offer that may still be accepted. An offer may have an expiration date after which the offer is no longer valid. In this regard, an outstanding offer may include: (i) offers that have already been received by the consumer, have not yet been accepted by the consumer, and are not past the expiration date; or (ii) offers that are scheduled to be sent to consumers (e.g., the system has decided to send the offer to the consumer, but has not yet transmitted the electronic communication to the consumer that includes the offer). Once an offer is accepted, the offer is no longer outstanding. Further, the number of deals that remain for purchase is decremented when the offer is accepted.

The outstanding offers may be used in combination with the number of deals that remain for purchase in order to determine the adjusted number of deals remaining. For example, one or more aspects of the outstanding offers, such as the number of outstanding offers, the estimated acceptance associated with the outstanding offers, and/or the amount of time remaining until expiration of the outstanding offers, may be used to determine the adjusted number of deals remaining.

In one embodiment, the adjusted number of deals remaining is based on the estimated acceptance associated with outstanding offers and the number of deals that remain for purchase. The estimated acceptance may be generated in one of several ways. One way to generate an estimated acceptance is by examining acceptances of previous offers for the deal program in order to generate an average acceptance rate. For example, if offers are on average accepted 10% and 100 offers are outstanding, the estimated acceptance is calculated to be 10 offers. In this regard, the estimated acceptance is independent of the attributes of the specific consumer. In an alternate embodiment, the estimated acceptance may be modified by a tuning parameter, enabling the issuance of offers to be more or less likely. In the example given, if the deal has an estimated acceptance of 10%, with 10 deals remaining, the system may send 100 offers, which will likely result in the 10 deals being purchased. However, in the event that the system wishes to throttle the number of offers being issued upward or downward, the tuning parameter may be used to modify the estimated acceptance. For example, if the system wishes to issue more offers, the tuning rate may be set to 0.2, so that the adjusted estimated acceptance rate is 10%*0.2 (or 2%). In this regard, given that there are still 10 deals remaining, the system may then send offers up to 500 consumers (instead of the 100 offers with the unadjusted estimated acceptance rate). As another example, if the system wishes to issue less offers, the tuning rate may be set to greater than 1.0.

Another way is to generate an estimated acceptance based on the specific consumer associated with the outstanding offer. More specifically, prior to sending an offer to a specific consumer, an estimate is generated of acceptance of the offer by the specific consumer. As discussed below, the estimate of acceptance of the offer by the specific consumer is based on one or more attributes of the specific consumer and one or more attributes of the deal program to which the deal belongs. In this regard, one, some, or all of the outstanding offers may have an estimated acceptance associated therewith. The estimated acceptance varies depending on the attributes of the specific consumer receiving the offer. So that, an estimated acceptance of the offer by consumer 1 may be different that an estimated acceptance of the offer by consumer 2. In a specific example, if there are 10 products still available for purchase, and if it is estimated that consumer 1 has a 0.1 chance of accepting the offer to purchase the product if offered, after sending the offer to consumer 1, while the offer to consumer 1 is outstanding, the indicator of the adjusted number of deals remaining is 9.9 (10−0.1) to reflect the possibility of consumer 1 accepting the outstanding offer. Likewise, if it is estimated that consumer 2 has a 0.2 chance of accepting the offer to purchase the product if offered, after sending the offer to consumer 2, while the offer to consumer 2 is outstanding, the indicator of the adjusted number of deals remaining is 9.8 (10−0.2) to reflect the possibility of consumer 2 accepting the outstanding offer. Once the offer to consumer 1 expires, the indicator may remove the effect of the outstanding offer to consumer 1 (e.g., changing the indicator of the adjusted number of deals remaining back to 10). In an alternate embodiment, the estimated acceptance may be modified by the tuning parameter, enabling the issuance of offers to be more or less likely. In the example given above, the tuning parameter may adjust the estimated acceptance of the specific consumer (such as consumer 1 and consumer 2). The tuning parameter may be selected to be 0.2 (meaning that it is 5 times more likely that an offer will be issued). For consumer 1 , the estimated acceptance=0.1, and the adjusted estimated acceptance=0.02. Similarly, for consumer 2, the estimated acceptance=0.2, and the adjusted estimated acceptance=0.04. In this regard, the system may issue more or fewer offers, whether the offers are based on an average acceptance or based on an acceptance specific to a consumer.

In still an alternate embodiment, the adjusted number of deals remaining is based on the estimated acceptance associated with outstanding offers, the time remaining to expiration of the outstanding offers, and the number of deals that remain for purchase. As discussed above, an offer may have a time period during which the offer is valid. The time period ends with the expiration date, after which the offer is no longer valid. In this regard, as the time remaining to accept the offer decreases, the likelihood that the consumer will accept the offer may likewise decrease. To account for the decreased likelihood of acceptance, the estimated acceptance may be modified (e.g., reduced) based on the time remaining to accept the offer. For example, one or more data constructs, such as a look-up table or a mathematical function, may be used in order to modify the estimated acceptance based on the time remaining to accept the offer. The data construct may comprise a linear function to generate a correction factor to multiple with the estimated acceptance, with time=0 (transmission of the offer) equal to 1.0 and time=expiration date (end of the offer) equal to 0. The data construct may comprise an empirical function based on historical data of acceptances. More specifically, the empirical function may be based on historical data of acceptance of deals from the specific deal program, may be based on historical data of acceptance of deals from deal programs that share an attribute with the specific deal program (e.g., the deal programs and the specific deal program are for “Chinese restaurants”), or may be based on historical data of acceptance for deals from any deal program. Finally, the adjusted number of deals still available may be updated at predetermined intervals, or may be updated when a determination whether to make an offer is made.

In one embodiment, the determination whether to send an offer to a specific consumer is based on the indicator of the adjusted number of deals still available and based on one or more aspects of the specific consumer. For example, the estimated acceptance of the offer by the specific consumer may be compared with the indicator in order to determine whether to offer the deal to the specific consumer, as discussed in more detail below. In this regard, the determination whether to send an offer to a specific consumer may be based on any combination of the following factors: the number of deals available; the estimate of acceptance by the specific consumer (or respective estimates for multiple specific consumers); and the offers that are outstanding but not yet accepted. As discussed in more detail below, the determination whether to offer the deal may be performed serially: selecting one of the specific consumers; determining whether to offer the deal to the selected specific consumer based on the selected specific consumer's respective estimate; and, if it is determined to offer the deal to the selected specific consumer, modify the indicator of the adjusted number of deals remaining, and then select the next specific consumer.

In an example where 100 deals are still available, examining one, some or all of the potential consumers may result in estimates that are different from the general one-in-ten estimate, yielding a more accurate prediction of the number of acceptances if the one or more potential customers are offered the deal, and in turn providing a better estimate as to the number of potential customers to offer the deal. As another example, if there are 100 deals still available for a deal program and if the relevance system has already decided to send offers to 10 users (so that the offers have been transmitted or are soon to be transmitted), the throttling system may examine the likelihood of acceptance of the 10 users in determining the indicator of the adjusted number of deals still available (in order to account for the outstanding offers).

Another example of throttling is where the number of offers or impressions for the particular deal is throttled upward. In the case of throttling upward, the number of offers or impressions that is transmitted is increased. In particular, there may be instances where a deal program is set to expire or end, and where the deal program still has a number of deals available for purchase or acceptance. As discussed in more detail below, the following factors may be used to determine which or how many potential customers to offer a deal from the deal program including: the number of deals available; one or more attributes of the potential customers (such as an estimate of the purchase of the deal); and optionally the time period remaining in the deal program

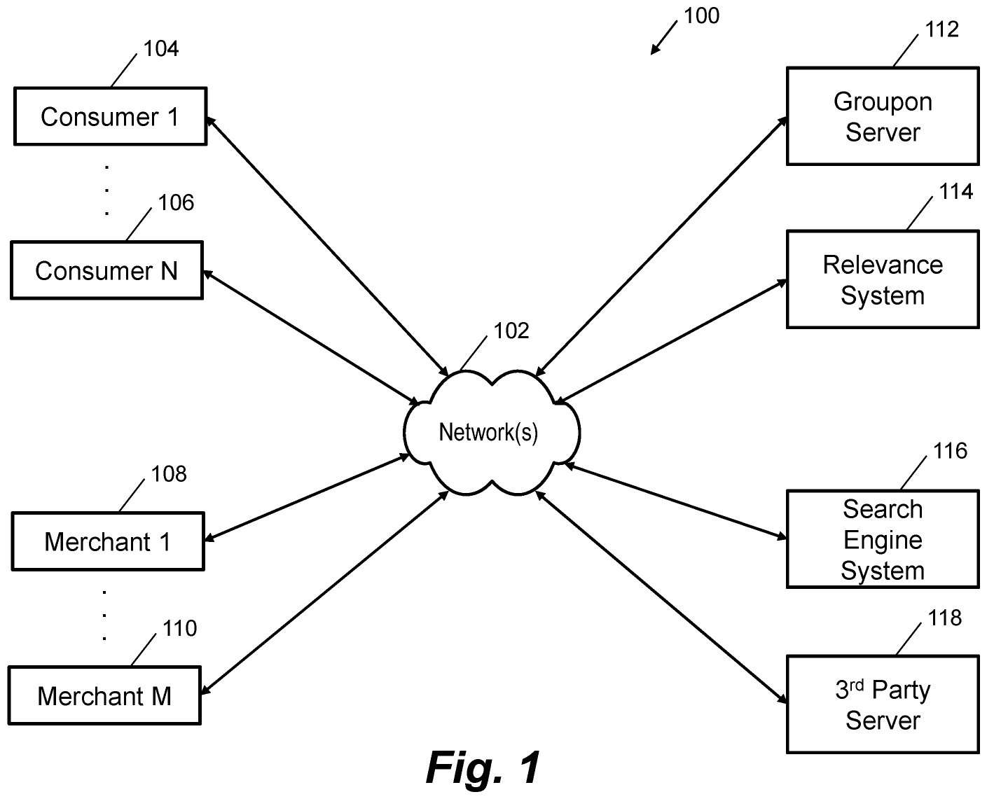

Referring to the figures, FIG. 1 illustrates an example of a network architecture 100 for a retailing system that includes relevance system 114 and network 102. The network 102 may include one or more wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

Relevance system 114 communicates with a variety of devices include consumer devices, merchant devices, servers (including servers that provide search engine capabilities and other website functionality). For example, one or more consumers, illustrated as Consumer 1 (104) to Consumer N (106), may communicate with network 102. The consumers may use any type of electronic device, such as a mobile computing device (e.g., a smartphone), a palmtop computer, a laptop computer, a desktop computer, or the like. In addition, one or more merchants, illustrated as Merchant 1 (108) to Merchant M (110), may communicate with network 102. The merchants may offer products or services that are subject to one or more deals, as discussed in more detail below. The depiction in FIG. 1 of “N” consumers and “M” merchants is merely for illustration purposes.

FIG. 1 further illustrates servers, such as Groupon® server 112 and 3^{rd} party server 118, and network functionality, such as search engine system 116. As illustrated in FIG. 1, relevance system 114 is depicted separately from Groupon® server 112. Alternatively, relevance system 114 may be integrated with Groupon® server 112.

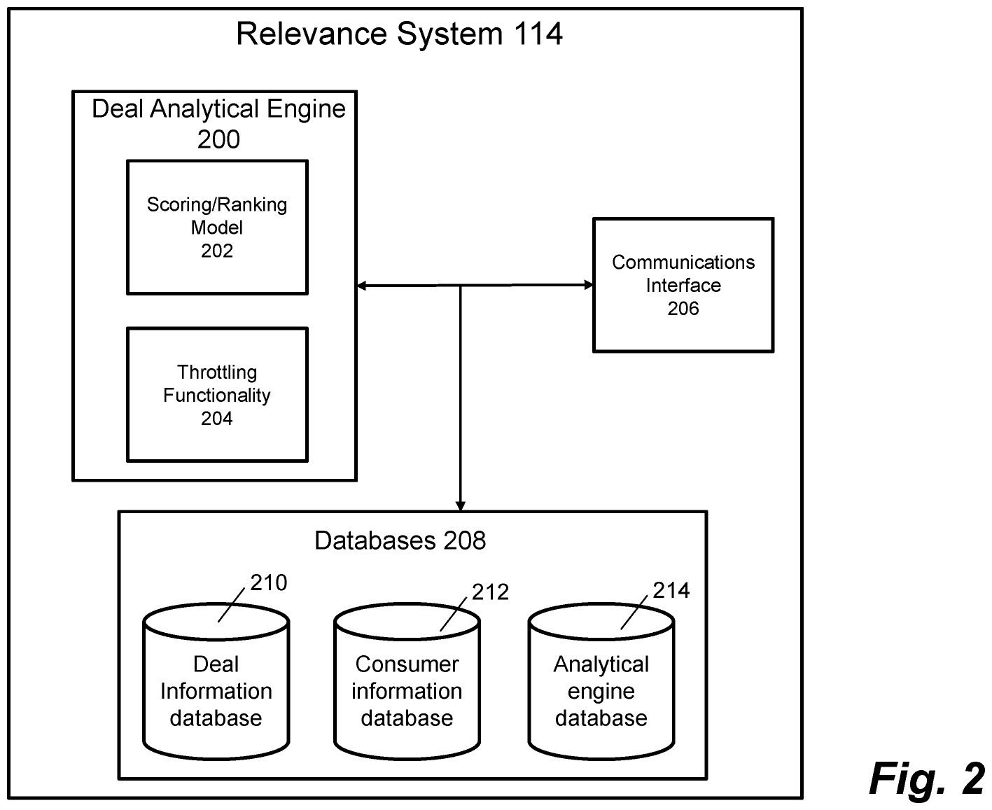

FIG. 2 illustrates an expanded block diagram of relevance system 114. Relevance system 114 may receive inputs from one or more input devices, such as, for example, from Groupon® server 112, search engine system 116, 3^{rd} party server 118, and/or consumer 1 (104) to consumer N (106). Relevance system 114 includes deal analytical engine 200, communications interface 206, and databases 208.

Deal analytical engine 200 may include a scoring/ranking model 202 and a throttling functionality 204. The scoring/ranking model 202 may be configured to examine one or more aspects of the consumers and generate score(s) for one or more deal programs. The scores may be based on what it is believed that the consumer seeks (whether based on explicit or implicit input by the consumer what the consumer seeks in a deal program and/or based on certain attributes of the consumer).

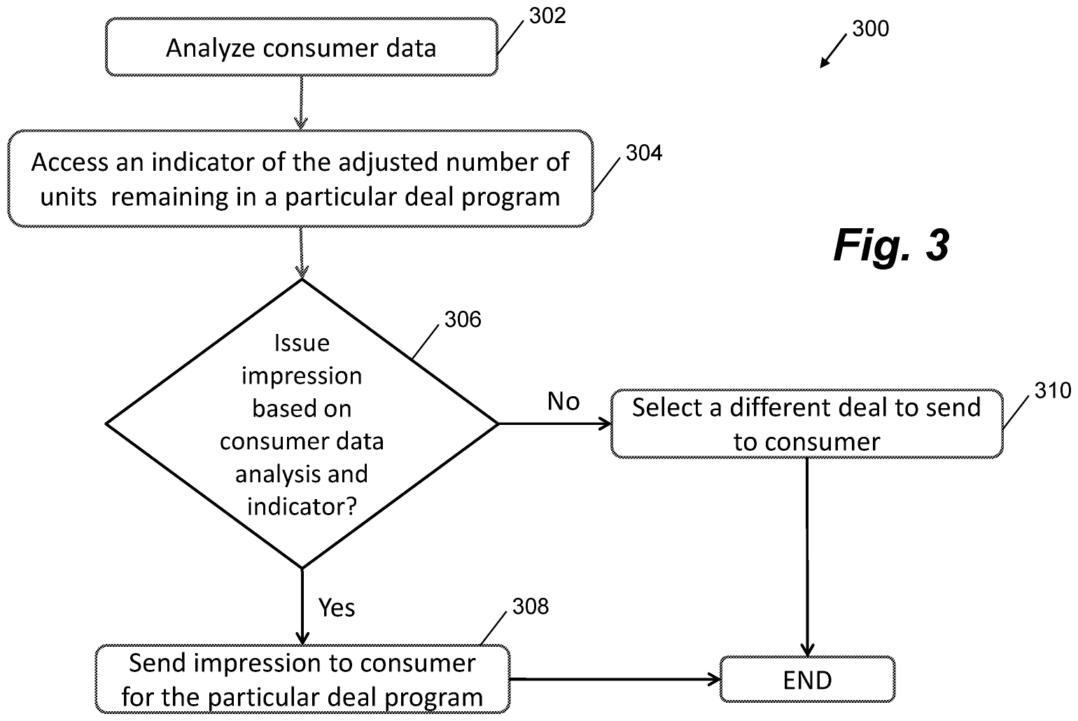

As illustrated in FIG. 2, the throttling functionality 204 is included in deal analytical engine 200, which is part of relevance system 114. Alternatively, throttling functionality 204 may be separate from deal analytical engine 200 and relevance system 114. Throttling functionality 204 may examine throttling on a deal program basis, on a deal program category basis, or on a deal program compilation basis, as discussed in more detail below. The throttling functionality 204 is described subsequently with respect to FIGS. 3-8.

FIG. 2 further illustrates databases 208, which includes deal information database 210, consumer information database 212, and analytical engine database 214. The deal information database 210 includes data related to the deals available for offer to consumers. As discussed above, deals include, but are not limited to, any type of promotion, reward, discount, coupon, credit, voucher or the like used toward part (or all) of the purchase of a product or a service. The consumer information database 212 includes data related to the consumers. The analytical engine database 214 includes data (other than deal data and consumer data) that is used by the deal analytical engine 200. FIG. 2 depicts deal information database 210, consumer information database 212, and analytical engine database 214 as separate databases. Alternatively, deal information database 210, consumer information database 212, and analytical engine database 214 may be included in a single memory device.

In one aspect, the scoring/ranking model 202 is configured to predict the likelihood that a consumer will accept an offer for a deal from a deal program (or predict the likelihood of accepting offers from a plurality of deal programs). One example of a scoring/ranking model 202 is disclosed in U.S. application Ser. No. 13/411,502, hereby incorporated by reference herein in its entirety. The prediction that a particular consumer will accept the offer is based on one or more attributes of the particular consumer. The indication of acceptance of the deal may take one of several forms, such as the conversion rate (e.g., the rate by which it is predicted that a consumer will accept a deal that is offered) or another type of score. To determine the conversion rate, the scoring/ranking model 202 is configured to examine one or more attributes of the consumer. For example, the scoring/ranking model 202 may examine information about a particular deal program (via the deal information database 210) and examine one or more attributes of a specific consumer (via the consumer information database 212) in order to generate the conversion rate of acceptance by the specific consumer if offered a deal from the particular deal program. The scoring/ranking model 202 may examine a variety of attributes of the specific consumer, including without limitation any combination of: the location, age, gender, and/or previous purchase history of the customer. In one embodiment, the scoring/ranking model 202 may score a single deal program. Alternatively, the scoring/ranking model 202 may score multiple deal programs. When the scoring/ranking model 202 generates scores for the multiple deal programs, the scoring/ranking model 202 may thereafter rank the multiple deal programs according the generated scores.

FIG. 3 illustrates a logic flow 300 of throttling on a deal program basis, which may include increasing or decreasing the sending of offers of a deal to consumers. At 302, consumer data is analyzed. As discussed above, the analysis of the consumer data may comprise analyzing one or more attributes for the consumer in order to generate an estimate of the consumer purchasing or accepting the deal if offered. The estimate of a particular consumer purchasing or accepting the offered deal may take several forms. At 304, an indicator of the adjusted number of units remaining for a particular deal program is accessed. As discussed above, the indicator of the adjusted number of units remaining for a particular deal program may account for the outstanding offers for deals from the particular deal program, as discussed in more detail below. At 306, it is determined whether to issue an impression to the consumer (such as sending an offer to purchase a deal), the determination being based on the consumer data analysis (e.g., based on the prediction that the particular consumer will accept the offer) and/or on the indicator of the adjusted number of units remaining.

If it is determined to send the impression, at 308, an impression is sent to the consumer for the particular deal program. Further, the indicator may be modified to reflect the sending of the impression to the consumer. If not, at 310, a different deal is selected to send to the consumer. As illustrated, FIG. 3 accounts for both the number of units remaining in the deal and an analysis of the particular consumer to receive the impression (such as an analysis of one or more attributes of the particular consumer) in making the throttling determination. Further, FIG. 3 may encompass throttling either downward (reducing the number of impressions or offers for deals) or upward (increasing the number of impressions or offers for deals).

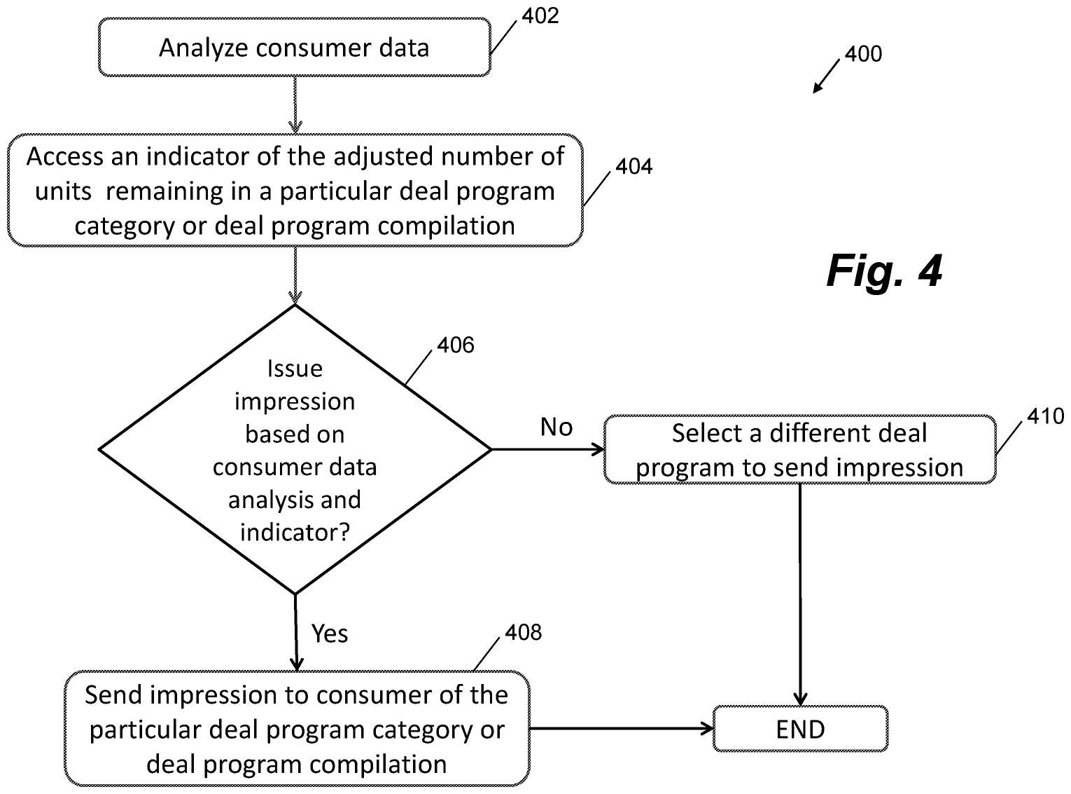

FIG. 4 illustrates a logic flow 400 of throttling on a deal program category basis or a deal program compilation basis. As discussed above, deals programs may have one or more attributes. The attributes may be used to categorize the deal programs. For example, one attribute may comprise a description of the type of deal program, such as a restaurant deal program (or a specific type of restaurant, such as an Italian restaurant). Another attribute may comprise the city or other geographic location for the deal program. Still another attribute may comprise a type of deal (such as an Easter deal). Likewise, the deal programs may be organized or grouped into a deal program compilation. The deal program compilation may include a collection of deal programs. The collection of deal programs may be based around specific attributes (see, for example, U.S. Application No. 61/663,508, incorporated by reference herein in its entirety) or actions of the consumers or may be independent of the specific consumer attributes. The throttling functionality may examine a deal program category or a deal program compilation. So that, a number of units may be assigned to a deal program category or a deal program compilation. For example, a particular category of deal, such as an Easter deal or other type of seasonal deal, may be throttled upward or downward. In particular, Easter deals may be throttled downward in October-December (during the Christmas holiday season) and may be throttled upward in February-April (leading up to the Easter Holiday.

At 402, consumer data is analyzed. At 404, an indicator of the number of units remaining for a particular deal program category or the particular deal program compilation is accessed. At 406, it is determined whether to issue an impression to the consumer, the determination being based on the consumer data analysis and on the indicator of the adjusted number of units remaining (either in the deal program category or deal program compilation). For example, a particular deal program category (such as restaurants) may be assigned a certain number of units for sale. If it is determined to send the impression, at 408, an impression is sent to the consumer for the particular deal program category or the particular deal program compilation. If not, at 410, a different deal is selected to send to the consumer.

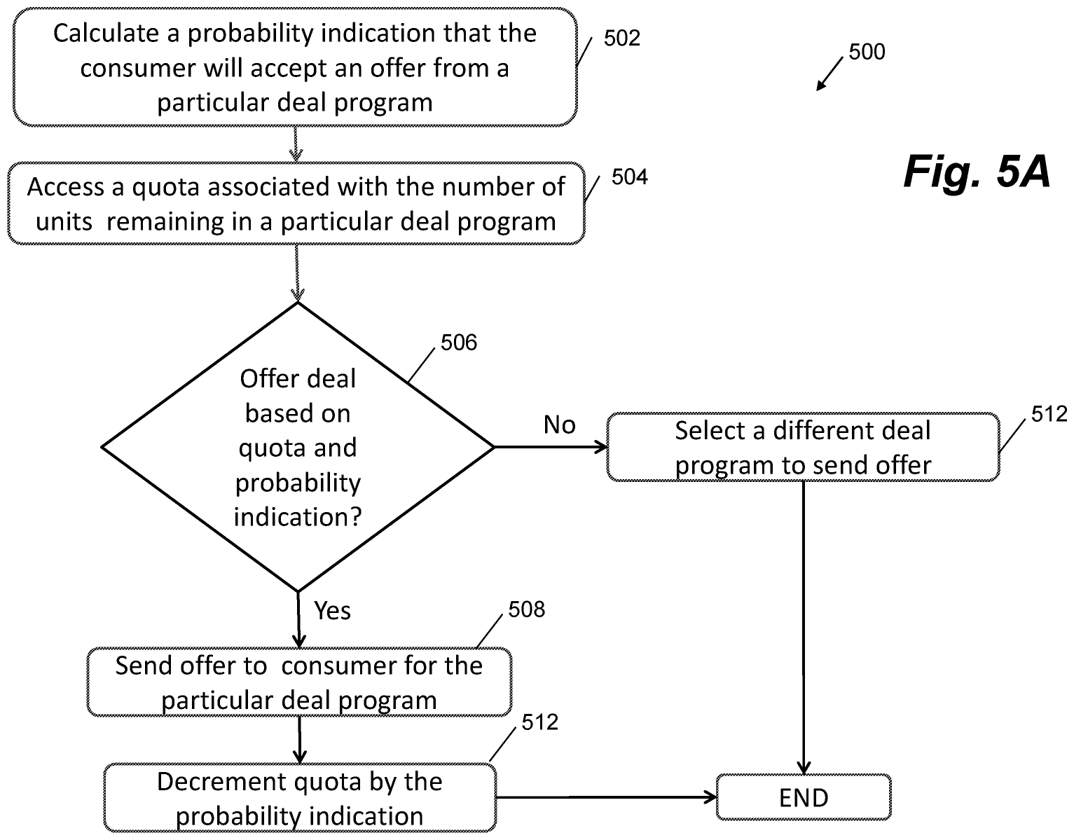

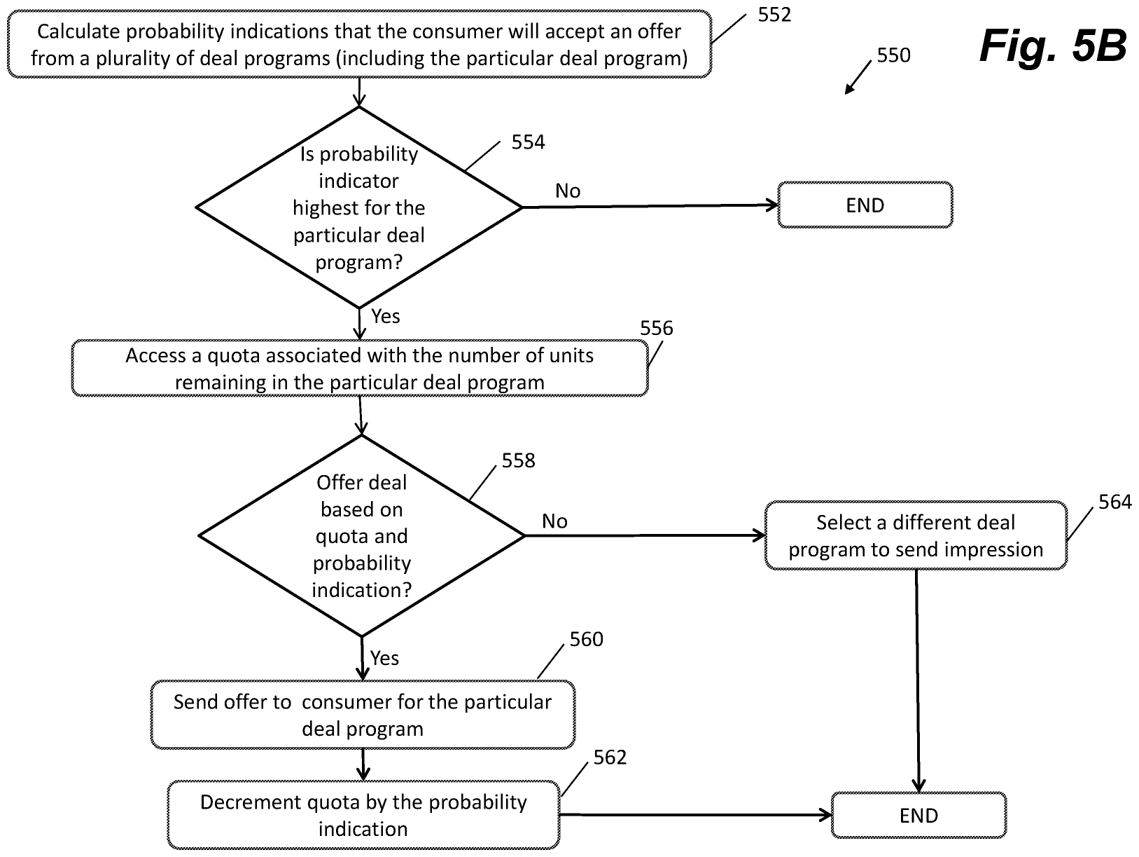

FIG. 5A is one example of an expanded logic flow 500 for FIG. 3. At 502, the probability indicator that the consumer will accept an offer for a particular deal program (or deal program category or deal program compilation) is calculated. As discussed above, an example of the probability indicator is the conversion rate. At 504, a quota associated with the number of units remaining in the particular deal program (or deal program category or deal program compilation) is accessed. The quota is an indicator of how many units remain available for purchase. The quota is one example of an indicator of the number of units remaining for a particular deal program. The quota may equal or be based on the number of units that are available for purchase for the particular deal program. Typically, offers are sent to the consumer with a time period in which to accept the offer. The time period may vary from a few hours, a day, two days, or longer. Further, offers may be made (e.g., sent) to multiple consumers. So that, there may be multiple offers that have been made to consumers which are still outstanding (e.g., within the time period for the consumer to accept the offer). The quota may provide an indication of the remaining units, accounting both for the units that have already been purchased and accounting for the probability of acceptances of the outstanding offers. For example, if 10 deals remain in a deal program and there are no outstanding offers, the quota is 10. If the probability that consumer “Y” will purchase a deal is 0.1, the quota if consumer “Y” is offered the deal is 9.9 (10 −0.1 (the probability that consumer “Y” will purchase the deal)). In still an alternate embodiment, the probability that consumer “Y” will purchase the deal may be weighted based on a time remaining during which consumer “Y” may purchase the deal. In the example above, the probability that consumer “Y” will purchase the deal is 0.1. Further, the time period during which consumer “Y” may purchase the deal is for a one week time period. The probability may be weighted (e.g., adjusted) depending on the amount of time remaining the time period. For example, if two days remain in the one week time period, the 0.1 probability of purchase of the deal may be weighted by 2/7. The weighting or adjustment based on remaining time may be linear, non-linear, or according to any weighting function. Thus, the quota may be used in combination with the probability indicator (e.g., the probability that a particular customer will purchase the deal) in determining whether to offer the deal to the particular customer.

At 506, it is determined whether to offer the deal based on the quota and the probability indicator. In one example, the deal is offered to the consumer if the quota−(minus) probability indicator≥0. In particular, if the quota is 9.9 and the probability indicator is 0.5, this indicates that there are enough deals remaining in the deal program to offer the deal to the consumer.

If it is determined to offer the deal to the consumer, at 508, the offer is sent to the consumer for the particular deal program. At 510, the quota is decremented by the probability indication. As discussed above, decrementing the quota by the probability indication accounts for the likelihood that the consumer will purchase the deal. If it is determined not to offer the deal to the consumer, at 512, a different deal program is selected to send to the consumer.

FIG. 5B is another example of an expanded logic flow 550 for FIG. 3 in which a multitude of deal programs, including the particular deal program subject to a limited number of deals available, are evaluated. As discussed above, the relevance system 114 may analyze multiple deal programs in order to decide which deal program is best to offer to the consumer. At 552, the probability indications that the consumer will accept an offer from a plurality of deal programs (including the particular deal program) are calculated. At 554, it is determined whether the probability indicator for the particular deal program is the highest. If not, the logic flow 550 ends. If the probability indicator for the particular deal program is highest, then a deal from the particular deal program is considered the best to offer. Put another way, the relevance system 114 may determine which particular deal program from among the multitude of deal programs has the highest probability indicator, and then determine whether to send an offer from this particular deal program to the consumer. At 556, the quota associated with the number of units remaining in the particular deal program is accessed. At 558, it is determined whether to offer the deal based on the quota and the probability indicator. If it is determined to offer the deal to the consumer, at 560, the offer is sent to the consumer for the particular deal program. At 562, the quota is decremented by the probability indication. If it is determined not to offer the deal to the consumer, at 564, a different deal program is selected to send to the consumer. For example, the relevance system 114 may select another deal program to consider offering to the consumer, including as examples randomly selecting another deal program, selecting the deal program from among the multitude of deal programs with a next highest probability indicator, or in any other way.

As discussed above, the throttling functionality may examine a set of consumers in determining whether to offer a deal. One issue when examining the set is determining the sequence of consumers to examine. In one embodiment, the throttling functionality uses a quota that is decremented as more consumers are offered the deal (so that, ultimately, the quota may be decremented to zero). If there are a large number in the set of consumers, the consumers examined first in the set are more likely to be offered the deal. The ordering or sequence of consumers may be based on one or more factors, such as a random selection or such as based on the probability indication.

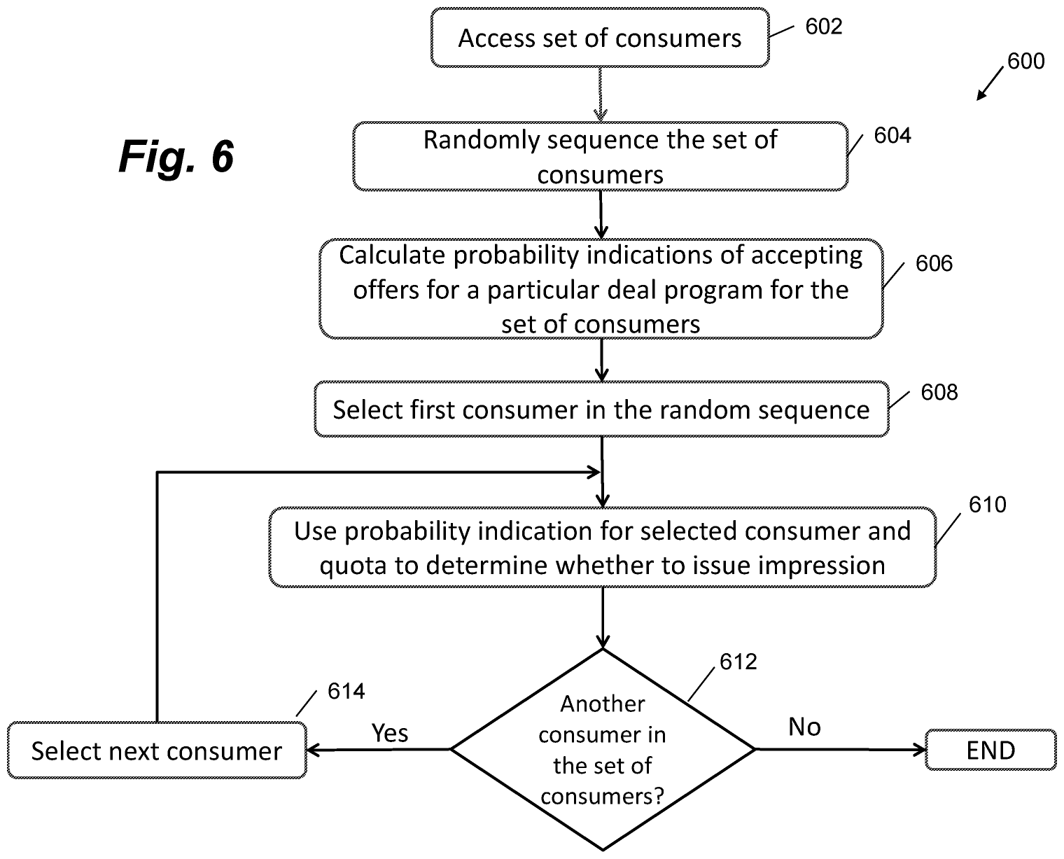

FIG. 6 is one example of a logic flow 600 for determining a sequence of consumers for examining whether to throttle an offer of a deal. At 602, the set of consumers are accessed. The set of consumers may be a randomly selected from a large set of consumers (e.g., the entire consumer pool) or according to one or more consumer attributes or other factors. The size of the set of consumers may be a configurable and/or predetermined number. The relevance system 114 may sequence the set of consumers. For example and as shown in FIG. 6, at 604, the set of consumers are randomly sequenced. One or more types of random sequencing are contemplated. After which, at 606, the probability indications of accepting a deal offer for the particular deal program are calculated for the set of users. As discussed above, the scoring/ranking model 202 may be used to calculate the probability indication. Alternatively, 604 may be performed after 606 so that the random sequence may be generated after calculating the probability indicators. At 608, the first consumer is selected in the random sequence. At 610, the probability indication for the selected consumer and the quota are used to determine whether to issue and impression. At 612, it is determined whether there is another consumer in the set of consumers. If so, at 614, the next consumer in the randomly sequences set of consumers is selected and the flow diagram loops back to 610.

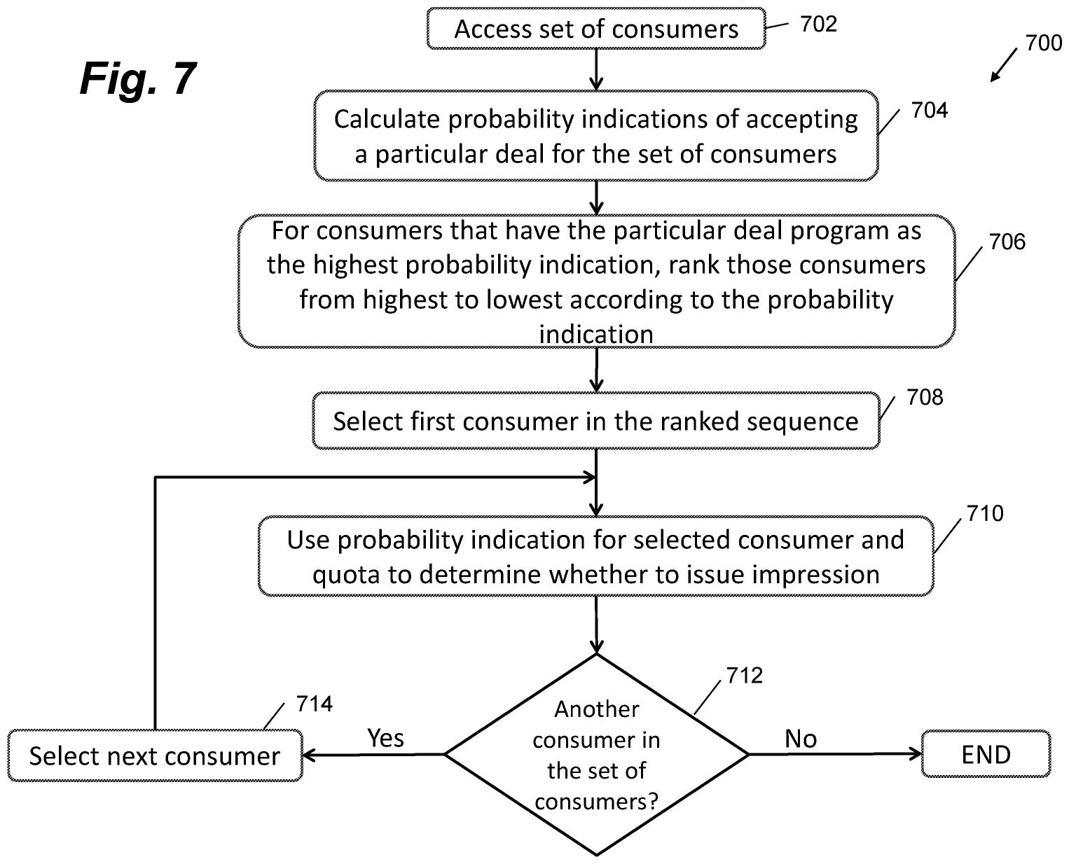

FIG. 7 is another example of a logic flow 700 for determining a sequence of consumers for examining whether to throttle an offer of a deal. At 702, the set of consumers are accessed, such as in any of the ways described above. At 704, the probability indications of accepting a deal offer for the particular deal program are calculated for the set of users. The relevance system 114 may sequence the set of consumers based on probability indications of the consumers. For example, at 706, tor consumers that have the particular deal program as the highest probability indication, those consumers are ranked from highest to lowest according to the probability indication. At 708, the first consumer is selected in the ranked sequence. At 710, the probability indication for the selected consumer and the quota are used to determine whether to issue and impression. At 712, it is determined whether there is another consumer in the set of consumers. If so, at 714, the next consumer in the ranked sequence of consumers is selected and the flow diagram loops back to 710.

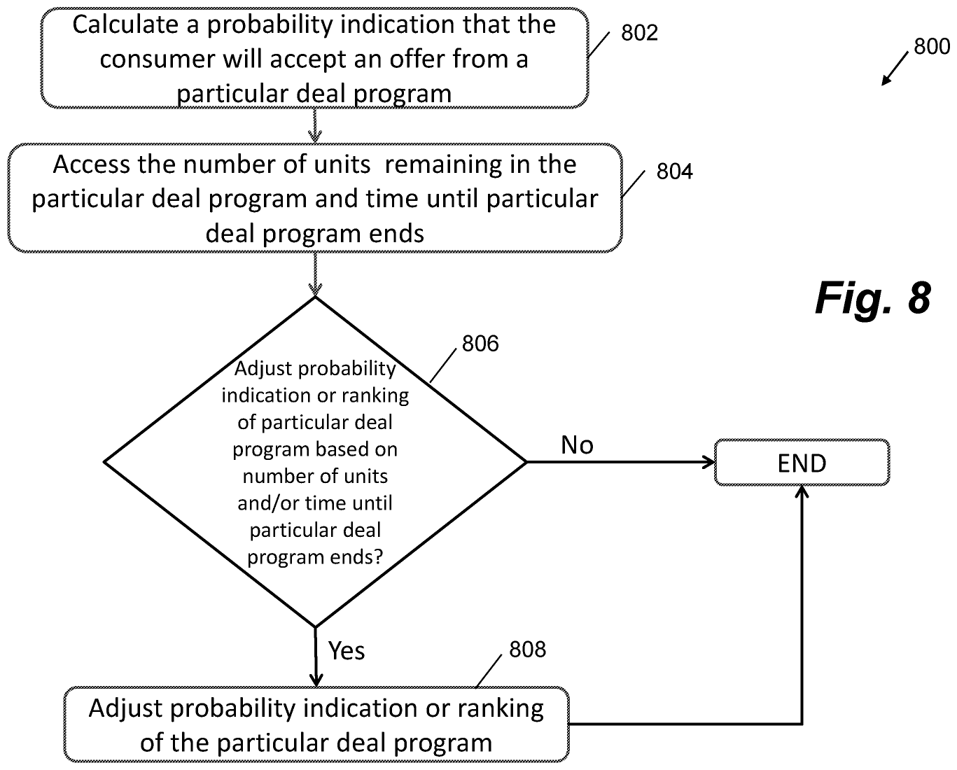

FIG. 8 is still another example of an expanded logic flow for FIG. 3 in which upward or downward throttling is considered. At 802, the probability indication that the consumer will accept an offer from a particular deal program is calculated. At 804, the number of units remaining in the particular deal program and time until particular deal program ends is accessed.

At 806, it is determined whether to adjust probability indication or ranking of particular deal program based on number of units and/or time until particular deal program ends. For example, if a particular deal program has a large number of units for sale and is expiring soon (as indicated by the time until particular deal program ends), the throttling functionality may determine to increase the offers for the particular deal program. In the event that the throttling functionality determines to increase the number of offers for the particular deal program, the throttling functionality 204 may accomplish this in one of several ways. As one example, the probability indication for the particular deal may be adjusted, e.g., increased. For example, the throttling functionality 204 may receive probability indications for one or more consumers determined by the scoring/ranking model 202, and adjust the determined probability indications in order to increase the likelihood of sending offers to consumers.

The increase in the determined probability indications may comprise a predetermined increase value. The increase value may be consistent for each consumer, or alternatively, may vary between consumers, e.g., based on a consumer attribute, based on the value of the probability indication prior to increase, or according to any number of other factors. Increasing the probability indication, in turn, increases the likelihood that the relevance system 114 will select the particular deal program to offer to the consumer. As another example, the ranking of the particular deal program may be adjusted (such as given a higher ranking) so that the relevance system 114 may be more likely to select the particular deal program to offer to the consumer. As still another example, a tuning parameter may be used in order to increase the likelihood that an offer is sent. In particular, rather than increasing the determined probability indications, the acceptances are adjusted (such as the average acceptance or the estimated acceptances specific to consumer(s)). As discussed above, if the system wishes to issue more offers, the tuning parameter may be set to 0.2, so that the adjusted estimated acceptance rate adjusted downward (e.g., from 10% to 2%). Likewise, the estimated acceptance specific to a consumer may be adjusted by the tuning parameter. The value of the tuning parameter may be selected based on a remaining time that the promotion program is still available to issue offers for promotions. For example, if the promotion program may still issue offers for several additional months, the tuning parameter may be set to 1.0 (meaning no effect of tuning). As another example, if the promotion program may issue offers only for a few more days, the tuning parameter may be set to 0.2 (meaning that the system would send 5 times the number of offers).

If it is determined to adjust the probability indication or ranking, at 808, the probability indication or ranking of the particular deal program is adjusted.

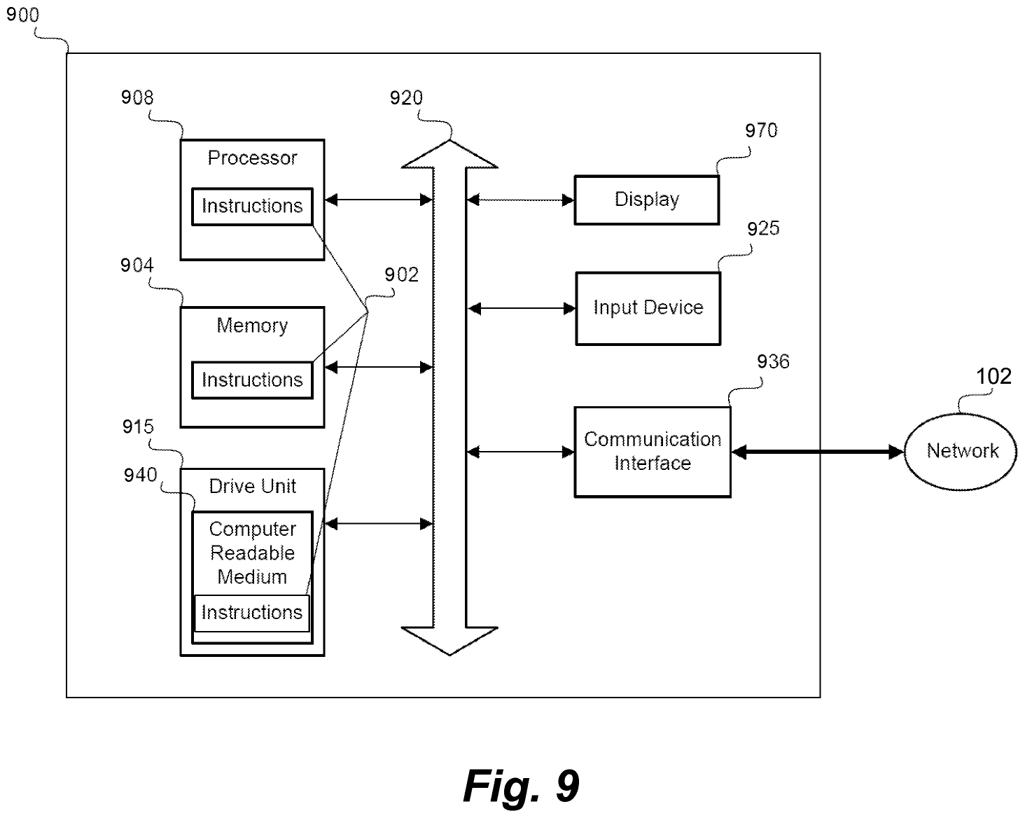

FIG. 9 illustrates a general computer system 900, programmable to be a specific computer system 900, which may represent any server, computer or component, such as consumer 1 (104), consumer N (106), merchant 1 (108), merchant M (110), Groupon® server 112, relevance system 114, search engine system 116, and 3^{rd} party server 118. The computer system 900 may include an ordered listing of a set of instructions 902 that may be executed to cause the computer system 900 to perform any one or more of the methods or computer-based functions disclosed herein. The computer system 900 may operate as a stand-alone device or may be connected, e.g., using the network 102, to other computer systems or peripheral devices.

In a networked deployment, the computer system 900 may operate in the capacity of a server or as a client-user computer in a server-client user network environment, or as a peer computer system in a peer-to-peer (or distributed) network environment. The computer system 900 may also be implemented as or incorporated into various devices, such as a personal computer or a mobile computing device capable of executing a set of instructions 902 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 900 may include a memory 904 on a bus 920 for communicating information. Code operable to cause the computer system to perform any of the acts or operations described herein may be stored in the memory 904. The memory 904 may be a random-access memory, read-only memory, programmable memory, hard disk drive or any other type of volatile or non-volatile memory or storage device.

The computer system 900 may include a processor 908, such as a central processing unit (CPU) and/or a graphics processing unit (GPU). The processor 908 may include one or more general processors, digital signal processors, application specific integrated circuits, field programmable gate arrays, digital circuits, optical circuits, analog circuits, combinations thereof, or other now known or later-developed devices for analyzing and processing data. The processor 908 may implement the set of instructions 902 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 900 may also include a disk or optical drive unit 915. The disk drive unit 915 may include a computer-readable medium 940 in which one or more sets of instructions 902, e.g., software, can be embedded. Further, the instructions 902 may perform one or more of the operations as described herein. The instructions 902 may reside completely, or at least partially, within the memory 904 and/or within the processor 908 during execution by the computer system 900. Accordingly, the databases 208 may be stored in the memory 904 and/or the disk unit 915.

The memory 904 and the processor 908 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 900 may include an input device 925, such as a keyboard or mouse, configured for a user to interact with any of the components of system 900. It may further include a display 970, such as a liquid crystal display (LCD), a cathode ray tube (CRT), or any other display suitable for conveying information. The display 970 may act as an interface for the user to see the functioning of the processor 908, or specifically as an interface with the software stored in the memory 904 or the drive unit 915.

The computer system 900 may include a communication interface 936 (such as communications interface 206) that enables communications via the communications network 102. The network 102 may include wired networks, wireless networks, or combinations thereof. The communication interface 936 network may enable communications via any number of communication standards, such as 802.11, 802.17, 802.20, WiMax, 802.15.4, cellular telephone standards, or other communication standards, as discussed above. Though, simply because one of these standards is listed does not mean that any one is preferred.

Further, relevance system 114, as depicted in FIG. 2, may comprise one computer system or a multitude of computer system (each working in concert to provide the functionality described in FIG. 2). For example, throttling functionality 204 may be included in one or more computer systems that perform the functionality of relevance system 114, as discussed above. Alternatively, throttling functionality 204 may be included in one or more computer systems separate from relevance system 114. Block diagrams of different aspects of the system, including FIGS. 1 and 2 may be implemented using the computer functionality disclosed in FIG. 9. Further, the flow diagrams illustrated in FIGS. 3-8 may use computer readable instructions that are executed by one or more processors in order to implement the functionality disclosed. Finally, the displays may be output on an I/O device.

The present disclosure contemplates a computer-readable medium that includes instructions or receives and executes instructions responsive to a propagated signal, so that a device connected to a network may communicate voice, video, audio, images or any other data over the network. Further, the instructions may be transmitted or received over the network via a communication interface. The communication interface may be a part of the processor or may be a separate component. The communication interface may be created in software or may be a physical connection in hardware. The communication interface may be configured to connect with a network, external media, the display, or any other components in system, or combinations thereof. The connection with the network may be a physical connection, such as a wired Ethernet connection or may be established wirelessly as discussed below. In the case of a service provider server, the service provider server may communicate with users through the communication interface.

The computer-readable medium may be a single medium, or the computer-readable medium may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an email or other self-contained information archive or set of archives may be considered a distribution medium that may be a tangible storage medium. The computer-readable medium is preferably a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1-22. (canceled)

23. A method for throttling communications with a plurality of consumer devices, the method comprising:
wherein the plurality of consumer devices are each associated with an associated consumer, and each consumer is associated with a preferred type of electronic correspondence;
wherein the plurality of consumer devices include at least a first set of consumer devices associated with a first set of consumers and a second set of consumer devices associated with a second set of consumers;
transmitting, to the first set of consumer devices, a first electronic correspondence, wherein the first electronic correspondence includes a deal from a deal program comprising an outstanding offer, wherein the first electronic correspondence is associated with an expiration date, and wherein the deal program is associated with a quota;
receiving a first set of electronic responses, wherein the first set of electronic responses comprises one or more electronic responses from one or more of the first set of consumer devices in response to the first electronic communication of the outstanding offer prior to the expiration date;
monitoring for an expiration of the expiration date prior to receiving a response from one or more of the first set of consumer devices not included in the first set of electronic responses;
generating an indicator based on the expiration of the expiration date and the responses from one or more of the first set of consumer devices;
determining to communicate with a first consumer of the second set of consumer, wherein the determination to communicate with the first consumer is based on the quota and the indicator;
generating a first communication to the first consumer device in the preferred type of electronic correspondence associated with a first consumer, wherein the first communication includes the deal; and
transmitting the first communication to the first consumer device.

24. The method of claim 1, wherein the electronic communication to the first set of consumer devices is transmitted via a batch transmission.

25. The method of claim 1, wherein the preferred type of electronic correspondence is one of email, text message, VOIP voice message, or push notification.

26. The method of claim 1, wherein determining to communicate with the first consumer is further based on a probability of acceptance associated with the first consumer.

27. The method of claim 26, wherein the probability of acceptance is a function based on one or more attributes of the specific consumer and one or more attributes of the deal program.

28. The method of claim 26, wherein the probability of acceptance is based on a tuning parameter, and wherein the tuning parameter is a function of time remaining before the expiration date.

29. The method of claim 26, wherein the probability of acceptance is based on an average acceptance rate associated with the deal program.

30. An apparatus comprising a processor and a non-transitory memory storing program instructions, wherein the non-transitory memory and the program instructions are configured to, with the processor, cause the apparatus to:
wherein the plurality of consumer devices are each associated with an associated consumer, and each consumer is associated with a preferred type of electronic correspondence;
wherein the plurality of consumer devices include at least a first set of consumer devices associated with a first set of consumers and a second set of consumer devices associated with a second set of consumers;
transmit, to the first set of consumer devices, a first electronic correspondence, wherein the first electronic correspondence includes a deal from a deal program comprising an outstanding offer, wherein the first electronic correspondence is associated with an expiration date, and wherein the deal program is associated with a quota;
receive a first set of electronic responses, wherein the first set of electronic responses comprises one or more electronic responses from one or more of the first set of consumer devices in response to the first electronic communication of the outstanding offer prior to the expiration date;
monitor for an expiration of the expiration date prior to receiving a response from one or more of the first set of consumer devices not included in the first set of electronic responses;
generate an indicator based on the expiration of the expiration date and the responses from one or more of the first set of consumer devices;
determine to communicate with a first consumer of the second set of consumer, wherein the determination to communicate with the first consumer is based on the quota and the indicator;
generate a first communication to the first consumer device in the preferred type of electronic correspondence associated with a first consumer, wherein the first communication includes the deal; and
transmit the first communication to the first consumer device.

31. The apparatus of claim 30, wherein the electronic communication to the first set of consumer devices is transmitted via a batch transmission.

32. The apparatus of claim 30, wherein the preferred type of electronic correspondence is one of email, text message, VOIP voice message, or push notification.

33. The apparatus of claim 30, wherein to determine to communicate with the first consumer is further based on a probability of acceptance associated with the first consumer

34. The apparatus of claim 33, wherein the probability of acceptance is a function based on one or more attributes of the specific consumer and one or more attributes of the deal program.

35. The apparatus of claim 33, wherein the probability of acceptance is based on a tuning parameter, and wherein the tuning parameter is a function of time remaining before the expiration date.

36. The apparatus of claim 33, wherein the probability of acceptance is based on an average acceptance rate associated with the deal program.

37. A computer-implemented method comprising:
wherein the plurality of consumer devices are each associated with an associated consumer, and each consumer is associated with a preferred type of electronic correspondence;
wherein the plurality of consumer devices include at least a first set of consumer devices associated with a first set of consumers and a second set of consumer devices associated with a second set of consumers;
transmitting, to the first set of consumer devices, a first electronic correspondence, wherein the first electronic correspondence includes a deal from a deal program comprising an outstanding offer, wherein the first electronic correspondence is associated with an expiration date, and wherein the deal program is associated with a quota;
receiving a first set of electronic responses, wherein the first set of electronic responses comprises one or more electronic responses from one or more of the first set of consumer devices in response to the first electronic communication of the outstanding offer prior to the expiration date;
monitoring for an expiration of the expiration date prior to receiving a response from one or more of the first set of consumer devices not included in the first set of electronic responses;
generating an indicator based on the expiration of the expiration date and the responses from one or more of the first set of consumer devices;
determining to communicate with a first consumer of the second set of consumer, wherein the determination to communicate with the first consumer is based on the quota and the indicator;
generating a first communication to the first consumer device in the preferred type of electronic correspondence associated with a first consumer, wherein the first communication includes the deal; and
transmitting the first communication to the first consumer device.

38. The computer-implemented method of claim 37, wherein the electronic communication to the first set of consumer devices is transmitted via a batch transmission.

39. The computer-implemented method of claim 37, wherein the preferred type of electronic correspondence is one of email, text message, VOIP voice message, or push notification.

40. The computer-implemented method of claim 37, wherein determining to communicate with the first consumer is further based on a probability of acceptance associated with the first consumer.

41. The computer-implemented method of claim 40, wherein the probability of acceptance is a function based on one or more attributes of the specific consumer and one or more attributes of the deal program.

42. The computer-implemented method of claim 40, wherein the probability of acceptance is based on a tuning parameter, and wherein the tuning parameter is a function of time remaining before the expiration date.
